(19) United States
(12) Patent Application Publication
(10) Pub. No.: US 2015/0285348 A1
(43) Pub. Date: Oct. 8, 2015

(54) Electric Linear Actuator

(71) Applicant: NTN Corporation, Osaka-shi (JP)

(72) Inventors: Yoshinori IKEDA, Iwata-shi (JP); Keisuke KAZUNO, Iwati-shi (JP); Kensuke FUNADA, Iwata-shi (JP); Kouji TATEISHI, Iwata-shi (JP)

(21) Appl. No.: 14/684,357

(22) Filed: Apr. 11, 2015

Related U.S. Application Data
(63) Continuation of application No. PCT/JP2013/077740, filed on Oct. 11, 2013.

(30) Foreign Application Priority Data
Oct. 12, 2012 (JP) 2012-227499

(51) Int. Cl. F16H 25/22; F16H 25/24

(52) U.S. Cl. CPC F16H 25/2204; F16H 25/24; F16H 2025/2031

(57) ABSTRACT

An electric linear actuator has a housing, an electric motor, a speed reduction mechanism and a ball screw mechanism. The electric linear actuator further includes an anti-rotation mechanism to prevent rotation of the screw shaft relative to the housing. The anti-rotation mechanism includes a sleeve and guide pin. The sleeve fits into a blind bore of the housing. The guide pin mounts on the end of the screw shaft, via a through aperture in the screw shaft. The guide pin engages linear recessed grooves of the sleeve. The sleeve is fit into a blind bore of the housing so that flat portions formed on an outer circumference of the sleeve engage flat surfaces formed on an inner circumference of the blind bore of the housing to prevent rotation of the sleeve relative to the housing.

### CROSS-REFERENCE TO RELATED APPLICATIONS

This application is a continuation of International Application No. PCT/JP2013/077740, filed Oct. 11, 2013, which claims priority to Japanese Application No. 2012-227499, filed Oct. 12, 2012. The disclosures of the above applications are incorporating herein by reference.

### FIELD

The present disclosure relates to an electric linear actuator with a ball screw mechanism used in motors in general industries and driving sections of automobiles etc. More particularly, it relates to an electric linear actuator used in automotive transmissions or parking brakes to convert rotary motion from the electric motor to linear motion of a drive shaft, via the ball screw mechanism.

### BACKGROUND

Generally, gear mechanisms, such as a trapezoidal thread worm gear mechanism or a rack and pinion gear mechanism, have been used as the mechanism to convert rotary motion of an electric motor to an axial linear motion in an electric linear actuator used in various kinds of driving sections. These motion converting mechanisms involve sliding contact portions. Thus, the power loss is increased. Accordingly, the size of the electric motor and power consumption are also increased. Thus, the ball screw mechanisms have been widely adopted as more efficient actuators.

In prior art electric linear actuators, an output member, connected to a nut, can be axially displaced by rotationally driving a ball screw shaft. The ball screw shaft forms a ball screw with use of an electric motor supported on a housing. Usually, the friction of the ball screw mechanism is very low. Thus, the ball screw shaft tends to be easily reversely rotated when a pushing thrust load is applied to the output member. Accordingly, it is necessary to hold the position of the output member when the electric motor is stopped.

Accordingly, an electric linear actuator has been developed with a brake arranged in the electric motor or a low efficient mechanism, such as a worm gear, is provided as a power transmitting mechanism. In FIG. 15, one representative example is shown. This electric linear actuator 100 adopts a ball screw mechanism 103 with a ball screw shaft 101 rotationally driven by an electric motor (not shown). A ball screw nut 102 threadably engages the ball screw shaft 101 via balls (not shown). A rotation of a motor shaft (not shown) of the electric motor causes a rotation of the ball screw shaft 101 connected to the motor shaft. This further causes a linear motion, motion in left-right directions in FIG. 15, of the ball screw nut 102.

The ball screw shaft 101 is rotationally supported on cylindrical housings 104, 105, via two rolling bearings 106, 107. These bearings 106, 107 are secured in position by a locking member 109, via a securing lid 108, to prevent loosening of the bearings 106, 107.

A helical screw groove 101a is formed on the outer circumference of the ball screw shaft 101. The ball screw nut 102 threadably engages the screw groove 101a, via balls. A helical screw groove 102a, corresponding to the helical screw groove 101a of the ball screw shaft 101, is formed on the inner circumference of the ball screw nut 102. A large diameter portion 110 is also formed on one end of the nut 102.

A flat portion 111, with a flat end face, is formed on the side of the large diameter portion 110 by cutting. A cam follower 112, an anti-rotation mechanism for the ball screw nut 102, using a rolling bearing projects radially outward from a substantially central portion of the flat portion 111. The cam follower 112 is engaged with a cut-out portion, not shown, formed on the housing 104.

As described above, the cam follower 112 is fit in the cut-out portion. Thus, accompanying rotation of the ball screw nut 102 to the rotation of the ball screw shaft 101 can be prevented. The cam follower 112 rotationally slides on the cut-out portion. This causes problems of sliding friction as well as wear that can be reduced (see JP 2007-333046 A

In the prior art electric linear actuator 100, the cam follower 112 acts as the anti-rotation mechanism for the ball screw nut 102. Thus, it is possible to reduce the problems of sliding friction as well as wear. Thus, this reduces operating torque of the electric linear actuator 100. However, since the cam follower itself uses the rolling bearing, the manufacturing cost would be increased and any anti-wear measures would be required when the housing 104 is formed from aluminum.

### SUMMARY

It is, therefore, an object of the present disclosure to provide an electric linear actuator with an anti-rotation mechanism for the screw shaft that is able to achieve a simple construction with low manufacturing cost and reduces the sliding friction and wear of the housing.

To achieve the object of the present disclosure, an electric linear actuator comprises a housing formed from an aluminum alloy. An electric motor is mounted on the housing. A speed reduction mechanism reduces rotational speed of the electric motor, via a motor shaft. A ball screw mechanism converts rotational motion of the electric motor, transmitted via the speed reduction mechanism, to axial linear motion of a drive shaft. The ball screw mechanism comprises a nut and a screw shaft. The nut is formed with a helical screw groove on its inner circumference. The nut is rotationally supported by bearings mounted on the housing but it is axially immovable with respect to the housing. The screw shaft is coaxially integrated with the drive shaft. A helical screw groove is formed on the screw shaft outer circumference corresponding to the helical screw groove of the nut. The shaft is inserted into the nut, via a large number of balls. The screw shaft is axially movably supported on the housing but it is not rotatable with respect to the housing. The electric linear actuator further comprises an anti-rotation mechanism for the screw shaft relative to the housing. The anti-rotation mechanism includes a sleeve and a guide pin. The sleeve is fit into the blind bore of the housing. The guide pin is mounted on the end of the screw shaft, via a through-aperture in the screw shaft. The guide pin engages the linear recessed grooves of the sleeve. The sleeve is fit into a blind bore of the housing. Flat portions formed on an outer circumference of the sleeve engage flat surfaces formed on an inner circumference of the blind bore of the housing. This prevents rotation of the sleeve relative to the housing.

A speed reduction mechanism reduces rotational speed of the electric motor, via a motor shaft. A ball screw mechanism converts rotational motion of the electric motor, transmitted via the speed reduction mechanism, to axial linear motion of a drive shaft. The ball screw mechanism includes a nut and a screw shaft. The nut includes a helical screw groove on its inner circumference. The nut is rotationally supported by bearings mounted on the housing but is axially immovable with respect to the housing. The screw shaft is coaxially integrated with the drive shaft. The screw shaft includes a helical screw groove on its outer circumference corresponding to the helical screw groove of the nut. The screw shaft is inserted into the nut, via a large number of balls. The screw shaft is axially movably supported on the housing but is not rotational with respect to the housing. A blind bore, formed on the housing, contains an end of the screw shaft. The electric linear actuator further comprises an anti-rotation mechanism for the screw shaft relative to the housing. The anti-rotation mechanism includes a sleeve and a guide pin. The sleeve is fit into the blind bore of the housing. The guide pin is mounted on the end of the screw shaft, via a through-aperture formed in the screw shaft. The guide pin engages linear recessed grooves of the sleeve. The sleeve is fit into a blind bore of the housing. Flat portions, formed on an outer circumference of the sleeve, engage flat surfaces formed on an inner circumference of the blind bore of the housing. This prevents rotation of the sleeve relative to the housing. Thus, the anti-rotation mechanism for the screw shaft of the electric linear actuator has a simple construction, a low manufacturing cost as well as reduced wear on the housing of the electric linear actuator.

The recessed grooves and the flat portions of the sleeve are formed, respectively, as one pair. They are positioned circumferentially opposite each other. The paired recessed grooves and the flat portions of the sleeve are positioned at circumferentially different phase positions to each other. This makes it possible to keep the strength and rigidity of the sleeve.

A small protruding ridge is formed on each flat portion of the sleeve. The ridge is press-fit onto the flat surfaces of the blind bore. This prevents rotation of the sleeve relative to the housing without any play.

A plurality of small protruding ridges are formed on the flat portions of the sleeve. This optimizes the press-fitting ability and allowable amount of play at the press-fit portion due to wear with time.

An electric linear actuator comprises a housing formed from aluminum alloy. An electric motor is mounted on the housing. A speed reduction mechanism reduces rotational speed of the electric motor, via a motor shaft. A ball screw mechanism converts rotational motion of the electric motor, transmitted via the speed reduction mechanism, to axial linear motion of a drive shaft. The ball screw mechanism comprises a nut and a screw shaft. The nut includes a helical screw groove on its inner circumference. The nut is rotationally supported by bearings mounted on the housing but is axially immovable with respect to the housing. The screw shaft is coaxially integrated with the drive shaft. The screw shaft includes a helical screw groove on its outer circumference corresponding to the helical screw groove of the nut. The screw shaft is inserted into the nut, via a large number of balls. The screw shaft is axially movably supported on the housing but is non-rotational with respect to the housing. The electric linear actuator further comprises an anti-rotation mechanism for the screw shaft relative to the housing. The anti-rotation mechanism includes a sleeve and a guide pin. The sleeve is fit into the blind bore of the housing. The guide pin is mounted on the end of the screw shaft, via a through-aperture formed in the screw shaft. The guide pin engages linear recessed grooves of the sleeve. The sleeve is fit into a blind bore of the housing. Projecting portions, each having a semicircular cross-section and formed on an outer circumference of the sleeve, engage recessed grooves. Each recessed groove has a circular-arc cross-section and is formed on an inner circumference of the blind bore of the housing. This prevents rotation of the sleeve relative to the housing.

A speed reduction mechanism reduces rotational speed of the electric motor, via a motor shaft. A ball screw mechanism converts rotational motion of the electric motor, transmitted via the speed reduction mechanism, to axial linear motion of a drive shaft. The ball screw mechanism comprises a nut and a screw shaft. The nut includes a helical screw groove on its inner circumference. The nut is rotationally supported by bearings mounted on the housing but is axially immovable with respect to the housing. The screw shaft is coaxially integrated with the drive shaft. The screw shaft includes a helical screw groove on its outer circumference corresponding to the helical screw groove of the nut. The screw shaft is inserted into the nut, via a large number of balls. The screw shaft is axially movably supported on the housing but is non-rotatable with respect to the housing. The electric linear actuator further comprises an anti-rotation mechanism for the screw shaft relative to the housing. The anti-rotation mechanism includes a sleeve and a guide pin. The sleeve is fit into the blind bore of the housing. The guide pin is mounted on the end of the screw shaft, via a through-aperture formed in the screw shaft. The guide pin engages linear recessed grooves of the sleeve. The sleeve is fit into a blind bore of the housing. Projecting portions, each having a semicircular cross-section, are formed on an outer circumference of the sleeve. The projecting portions engage recessed grooves, each having a circular-arc cross-section, formed on an inner circumference of the blind bore of the housing. This prevents rotation of the sleeve relative to the housing. Thus, the anti-rotation mechanism for the screw shaft of the electric linear actuator has a simple construction, a low manufacturing cost as well as reduced wear on the housing of the electric linear actuator.

The radius of curvature of the recessed groove of the blind bore of the housing is smaller than that of the projecting portion of the sleeve. This prevents rotation of the sleeve relative to the housing without any play.

The blind bore of the housing is formed with a guiding portion. The guiding portion has a cone configuration concentrated toward the recessed portion. This makes it possible to smoothly and precisely press-fit the sleeve into the blind bore of the housing. Thus, this improves the assembly operation without preparing special assembling devices such as positioning jigs.

The blind bore of the housing is formed with an annular groove. A stopper ring is snap-fit into the annular groove. The peripheral edge of the stopper ring is tapered. This firmly secures the sleeve without axial play due to pressure applied by the stopper ring against the end face of the sleeve.

Finally, the sleeve is formed by a cold rolling method. The blind bore is formed by an aluminum die casting method. This improves mass-productivity and reduces manufacturing cost.

The electric linear actuator housing is formed from aluminum alloy. An electric motor is mounted on the housing. A speed reduction mechanism reduces rotational speed of the electric motor via a motor shaft. A ball screw mechanism converts rotational motion of the electric motor, transmitted via the speed reduction mechanism, to axial linear motion of a drive shaft. The ball screw mechanism comprises a nut and a screw shaft. The nut includes a helical screw groove on its inner circumference. The nut is rotationally supported by bearings mounted on the housing but is axially immovable with respect to the housing. The screw shaft is coaxially integrated with the drive shaft. The screw shaft includes a helical screw groove on its outer circumference corresponding to the helical screw groove of the nut. The screw shaft inserts into the nut, via a large number of balls. The screw shaft is axially movably supported on the housing but is non-rotational with respect to the housing. The electric linear actuator further comprises an anti-rotation mechanism for the screw shaft relative to the housing. The anti-rotational mechanism includes a sleeve and a guide pin. The sleeve fits into the blind bore of the housing. The guide pin is mounted on the end of the screw shaft, via a through-aperture formed in the screw shaft. The guide pin engages linear recessed grooves of the sleeve. The sleeve is fit into a blind bore of the housing. Flat portions, formed on an outer circumference of the sleeve, engage flat surfaces formed on an inner circumference of the blind bore of the housing. This prevents rotation of the sleeve relative to the housing. Thus, the anti-rotation mechanism for the screw shaft of the electric linear actuator has a simple construction, a low manufacturing cost as well as reduced wear on the housing of the electric linear actuator.

The electric linear actuator includes a housing formed of aluminum alloy. An electric motor is mounted on the housing. A speed reduction mechanism reduces rotational speed of the electric motor, via a motor shaft. A ball screw mechanism converts rotational motion of the electric motor, transmitted via the speed reduction mechanism, to axial linear motion of a drive shaft. The ball screw mechanism comprises a nut and a screw shaft. The nut includes a helical screw groove on its inner circumference. The nut is rotationally supported by bearings mounted on the housing but is axially immovable with respect to the housing. The screw shaft is coaxially integrated with the drive shaft. The screw shaft includes a helical screw groove on its outer circumference corresponding to the helical screw groove of the nut. The screw shaft inserts into the nut, via a large number of balls. The screw shaft is axially movably supported on the housing but is non-rotatable with respect to the housing. The electric linear actuator further comprises an anti-rotation mechanism for the screw shaft relative to the housing. The anti-rotation mechanism includes a sleeve and a guide pin. The sleeve fits into the blind bore of the housing. The guide pin mounts on the end of the screw shaft, via a through-aperture formed in the screw shaft. The guide pin engages linear recessed grooves of the sleeve. The sleeve is fit into a blind bore of the housing so that projecting portions, each having a semicircular cross-section and formed on an outer circumference of the sleeve, engage recessed grooves, each having a circular-arc cross-section, formed on an inner circumference of the blind bore of the housing. This prevents rotation of the sleeve relative to the housing. Thus, the anti-rotation mechanism for the screw shaft of the electric linear actuator has a simple construction, a low manufacturing cost as well reduced wear on the housing of the electric linear actuator.

Further areas of applicability will become apparent from the description provided herein. The description and specific examples in this summary are intended for purposes of illustration only and are not intended to limit the scope of the present disclosure.

### DRAWINGS

The drawings described herein are for illustrative purposes only of selected embodiments and not all possible implementations, and are not intended to limit the scope of the present disclosure.

FIG. 1 is a longitudinal section view of a first embodiment of an electric linear actuator.

FIG. 2 is a longitudinal section view of an actuator main body of FIG. 1.

FIG. 3 is an enlarged cross-sectional view of an intermediate gear portion of FIG. 1.

FIG. 4 is an enlarged cross-sectional view of a modification of the intermediate gear portion of FIG. 3.

FIG. 5 is a front elevation view of a second housing of the electric linear actuator of FIG. 1.

FIG. 6(a) is a front elevation view of the sleeve of FIG. 5.

FIG. 6(b) is a side elevation view of the sleeve of FIG. 6(a).

FIG. 6(c) is a perspective view of a modification of the sleeve of FIG. 6(a).

FIG. 7 is a longitudinal section view of the second housing of FIG. 1.

FIG. 8 is a perspective view of the second housing of FIG. 1.

FIG. 9 is a longitudinal section view of a second embodiment of an electric linear actuator.

FIG. 10(a) is a front elevation view of a sleeve of FIG. 9.

FIG. 10(b) is a longitudinal section view taken along a line X-X of FIG. 10(a).

FIG. 11 is a cross-section view taken along a line XI-XI of FIG. 9.

FIG. 12(a) is a front elevation view of a modification of the sleeve of FIG. 10.

FIG. 12(b) is a cross-section view taken along a line XII-XII of FIG. 12(a).

FIG. 12(c) is a rear elevation view of the sleeve of FIG. 12(a).

FIG. 13(a) is a front elevation view of a bottom plate of the sleeve of FIG. 12.

FIG. 13(b) is a cross-section view taken along a line XIII-XIII of FIG. 13(a).

FIG. 13(c) is a rear elevation view of the bottom plate of the sleeve of FIG. 13(a).

FIG. 14(a) is a front elevation view of another modification of the sleeve of FIG. 10.

FIG. 14(b) is a side elevation view of the sleeve of FIG. 14(a).

FIG. 15 is a longitudinal section view of a prior art electric linear actuator.

### DETAILED DESCRIPTION

An electric linear actuator includes a housing with an electric motor mounted on the housing. A speed reduction mechanism reduces rotational speed of the electric motor, via a motor shaft. A ball screw mechanism converts rotational motion of the electric motor, transmitted via the speed reduction mechanism, to axial linear motion of a drive shaft. The ball screw mechanism includes a nut and a screw shaft. The nut includes a helical screw groove on its inner circumference. The nut is rotationally supported by bearings mounted on the housing but is axially immovable with respect to the housing. The screw shaft is coaxially integrated with the drive shaft. The screw shaft includes a helical screw groove on its outer circumference corresponding to the helical screw groove of the nut. The screw shaft inserts into the nut, via a large number of balls. The screw shaft is axially movably supported on the housing but is not rotatable with respect to the housing. A blind bore, formed on the housing, contains an end of the screw shaft. A sleeve, formed on its inner circumference with axially extending recessed grooves, is fit into the blind bore of the housing. A pin, mounted on one end of the screw shaft, engages the recessed grooves. Flat portions, formed on an outer circumference of the sleeve, engage flat surfaces formed on an inner circumference of the blind bore of the housing. This prevents rotation of the sleeve relative to the housing.

Preferred embodiments and modifications of the present disclosure will be hereinafter described with reference to the drawings.

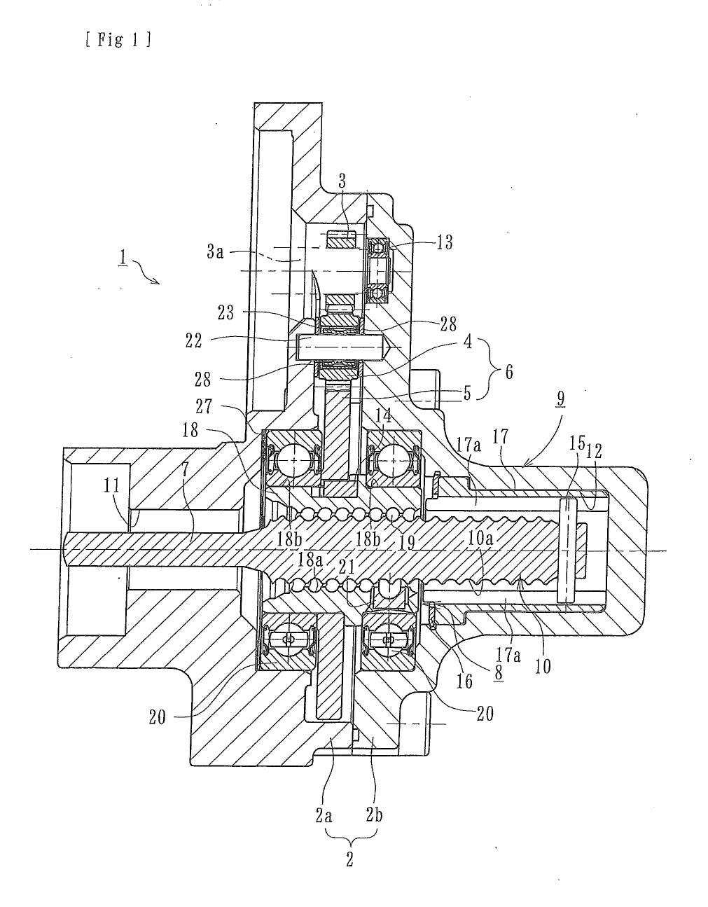

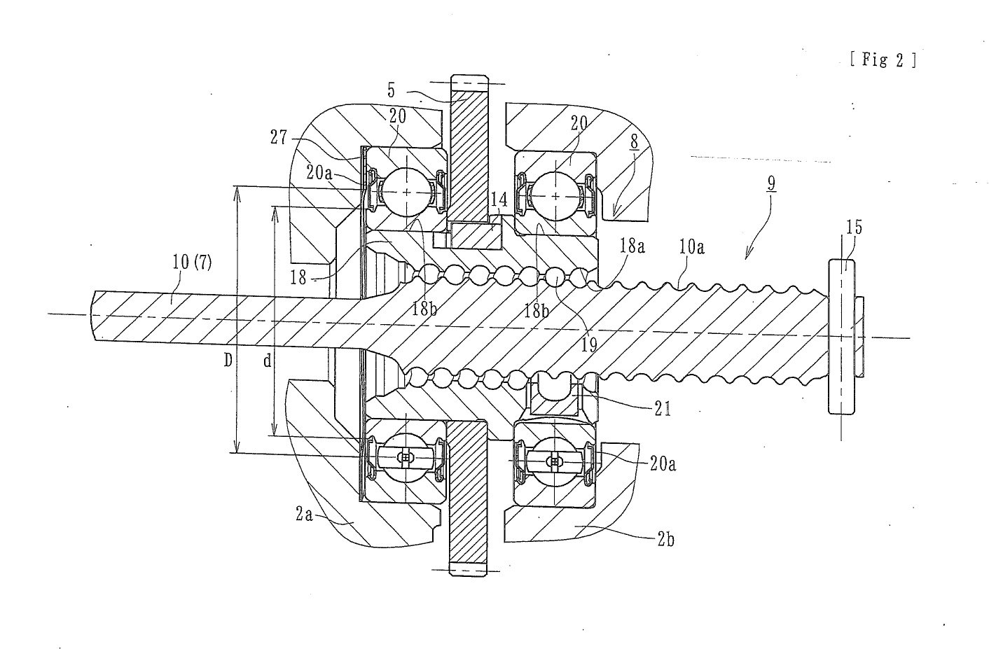

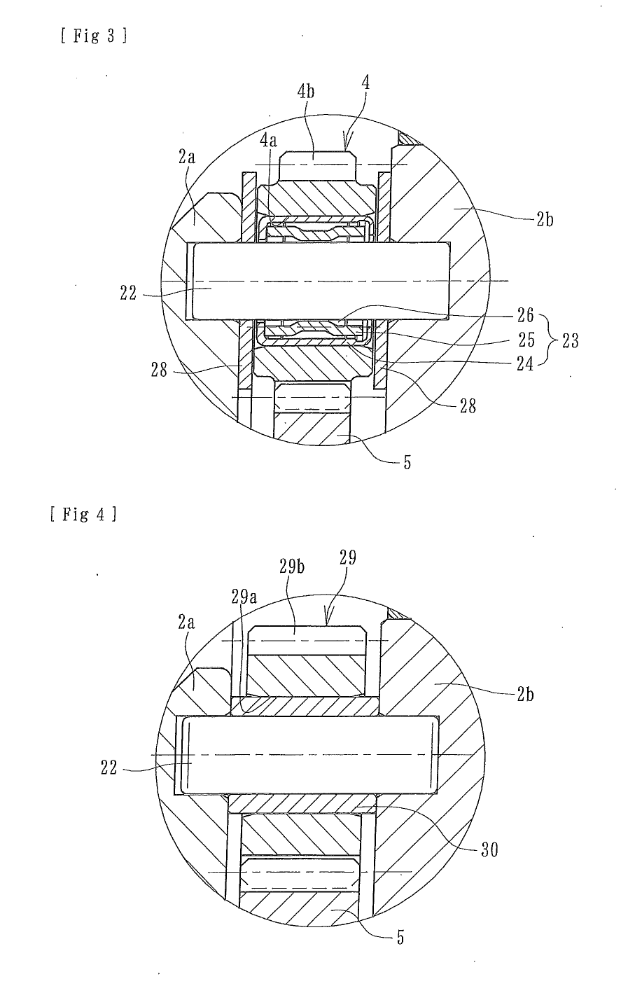

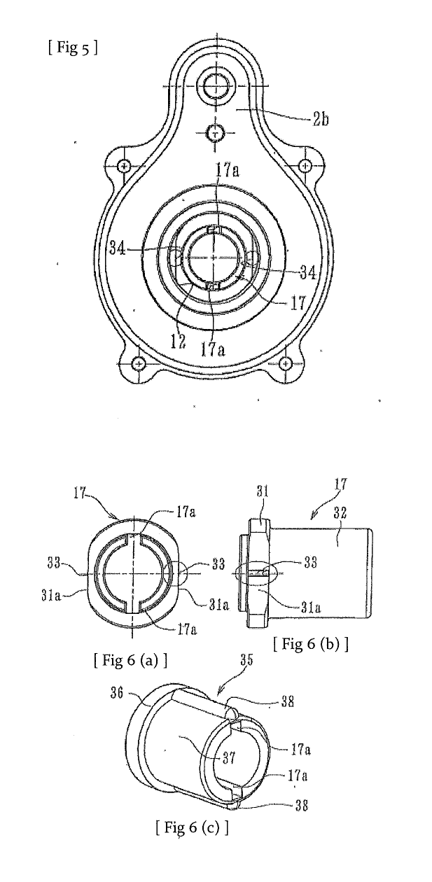

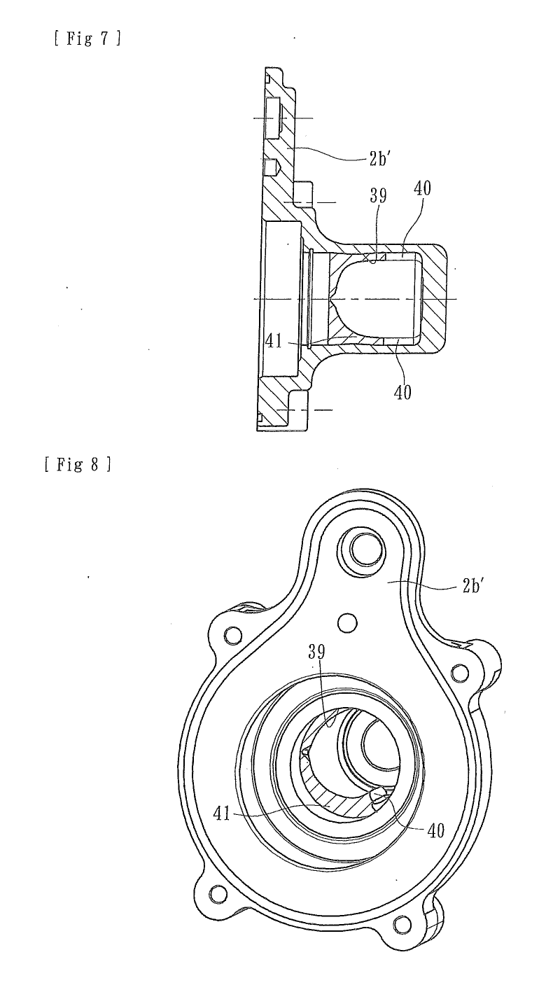

FIG. 1 is a longitudinal section view of a first embodiment of an electric linear actuator. FIG. 2 is a longitudinal section view of an actuator main body of FIG. 1. FIG. 3 is an enlarged cross-sectional view of an intermediate gear portion of FIG. 1. FIG. 4 is an enlarged cross-sectional view of a modification of the intermediate gear portion of FIG. 3. FIG. 5 is a front elevation view of a second housing of the electric linear actuator of FIG. 1. FIG. 6(a) is a front elevation view of the sleeve of FIG. 5. FIG. 6(b) is a side elevation view of the sleeve of FIG. 6(a). FIG. 6(c) is a perspective view of a modification of the sleeve of FIG. 6(a). FIG. 7 is a longitudinal section view of the second housing of FIG. 1. FIG. 8 is a perspective view showing the second housing of FIG. 1.

As shown in FIG. 1, an electric linear actuator 1 has a cylindrical housing 2. An electric motor (not shown) is mounted on the housing 2. An intermediate gear 4 mates with an input gear 3 mounted on the motor shaft 3a of the motor. A speed reduction mechanism 6 has an output gear 5 mating with the intermediate gear 4. A ball screw mechanism 8 converts rotational motion of the electric motor, transmitted via the speed reduction mechanism 6, to axial linear motion of a drive shaft 7. An actuator main body 9 includes the ball screw mechanism 8.

The housing 2 is formed of aluminum alloy such as A 6063 TE, ADC 12 etc. The housing includes a first housing 2a abutting a second housing 2b integrally fastened to each other by fastening bolts (not shown). The electric motor is mounted on the first housing 2a. Blind bores 11, 12, for containing a screw shaft 10, are formed in the first and second housings 2a, 2b, respectively.

The input gear 3 is press-fit onto the motor shaft 3a of the electric motor. The motor shaft 3a is rotationally supported by a deep groove rolling bearing 13 mounted on the second housing 2b. The output gear 5, mating with the intermediate spur gear 4, is integrally secured via a key 14 on a nut 18. The nut 18 forms a portion of the the ball screw mechanism 8 described later in more detail.

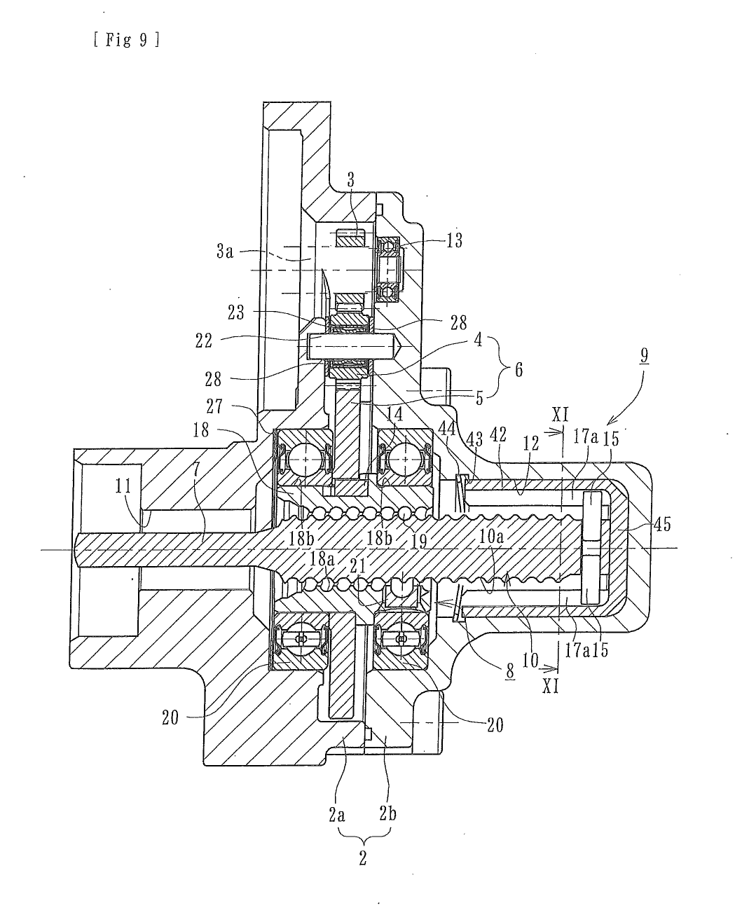

The drive shaft 7 is formed integrally with the screw shaft 10, forming a portion of the ball screw mechanism 8. A guide pin 15 is mounted on one end (the right end in FIG. 1) of the drive shaft 7. In addition, a sleeve 17, described later in more detail, is fit in the blind bore 12 of the second housing 2b. The sleeve 17 is axially secured by a stopper ring 16 snapped in an annular groove (e.g. annular groove 43 in FIG. 9). The guide pin 15 of the screw shaft 10 engages axially extending recessed grooves 17a, 17a, formed on the inner circumference of the sleeve 17, so that the screw shaft 10 can be axially moved but not rotated relative to the sleeve 17, thus, relative to the housing 2b.

The guide pin 15 is formed of high carbon chrome bearing steel such as SW 2 or blister bearing steel such as SCr 435. Its surface is formed with a carbonitriding layer including carbon of 0.80% by weight or more having a hardness of HRC 58 or more. In this case, it is possible to adopt needle rollers used in needle bearings as the guide pins. Thus, the guide pin has a hardness of HRC 58 or more. The guide pin has excellent anti-wear properties, availability and manufacturing cost.

According to the present embodiment, the tip or peripheral edge of the stopper ring 16 is tapered. This firmly secures the sleeve without axial play. The sleeve 17 can be urged toward the right (FIG. 1) by pressure applied by the stopper ring 16 against the end face of the sleeve 17.

As shown in the enlarged view of FIG. 2, the ball screw mechanism 8 includes the screw shaft 10 and the nut 18. The nut 18 mates with the screw shaft 10, via balls 19. The screw shaft 10 includes a helical screw groove 10a on its outer circumference. The nut 18, on its inner circumference, includes screw groove 18a corresponding to the screw groove 10a of the screw shaft 10. A plurality of balls 19 are rollably contained between the screw grooves 10a, 18a. The nut 18 is rotationally supported by two supporting bearings 20, 20 but is axially immovable relative to the housings 2a, 2b. A numeral 21 denotes a bridge member to achieve an endless circulating passage of balls 19 through the screw groove 18a of the nut 18.

The cross-sectional configuration of each screw groove 10a, 18a may be either one of circular-arc or Gothic-arc configuration. However, this embodiment adopts the Gothic-arc configuration. This configuration has a large contacting angle with the ball 19 and a small axial gap. This provides a large rigidity against the axial loads and thus suppresses the generation of vibration.

The nut 18 is formed of case hardened steel such as SCM 415 or SCM 420. Its surface is hardened to HRC 55 to 62 by vacuum carburizing hardening. This omits treatments, such as buffing for scale removal after heat treatment, and thus reduces the manufacturing cost. The screw shaft 10 is formed of medium carbon steel such as S55C or case hardened steel such as SCM 415 or SCM 420. Its surface is hardened to HRC 55 to 62 by induction hardening or carburizing hardening.

The output gear 5 forming part of the speed reduction mechanism 6 is firmly secured on the outer circumference 18b of the nut 18. The support bearing 20, 20 are press-fit onto the nut 18, via a predetermined interface, at both sides of the output gear 5. This prevents both the supporting bearings 20, 20 and the output gear 5 from being axially shifted even though a strong thrust load would be applied to them from the drive shaft 7. Each supporting bearing 20 includes the deep groove ball bearing with the shield plates 20a, 20a mounted on both sides. The shield plates 20a, 20a prevent lubricating grease, sealed within the bearing body, from leaking outside and abrasives from entering into the bearing body from the outside.

In the illustrated embodiment, both the supporting bearings 20, 20 are formed by deep groove ball bearing with the same specifications. Thus, it is possible to support both a thrust load, applied from the drive shaft 7, and a radial load applied from the output gear 5. Also, it simplifies confirmation work by preventing errors in assembly of the bearing. Thus, this improves the assembly operation. In this case, the term “same specifications” means that bearings have the same inner diameters, outer diameters, width dimensions, rolling element sizes, rolling element numbers and internal clearances.

In the illustrated embodiment, one of the paired supporting bearings 20, 20 is mounted on the first housing 2a, via a ring shaped elastic washer 27. The washer 27 is a wave-washer press-formed from austenitic stainless steel sheet (e.g. SUS 304 family of JIS) or preservative cold rolled steel sheet (e.g. SPCC family of JIS). An inner diameter “D” of the wave washer 27 is formed larger than an outer diameter “d” of the inner ring of the supporting bearing 20. This eliminates axial play of the paired bearings 20, 20. Thus, a smooth rotation is obtained. In addition, the washer 27 contacts only the outer ring of the bearing 20 and does not contact its rotational inner ring. Thus, this prevents the inner ring of the bearing 20 from abutting against the housing 2a and thus being locked by the housing 2a even though the nut 18 is urged by a reverse thrust load toward the housing 2a.

As shown in FIG. 3, the intermediate gear 4 is rotationally supported by a gear shaft 22 mounted on the first and second housings 2a, 2b, via a rolling bearing 23. When one end of the gear shaft 22 is press-fit into an aperture of the first housing 2a, the other end of the gear shaft 22 is mounted in an aperture of the second housing 2b by a clearance fit. Thus, assembling misalignment is accounted for and smooth rotational performance of the rolling bearing 23 and the intermediate gear 4 is obtained. In the illustrated embodiment, the rolling bearing 23 is a so-called “shell type” needle roller bearing. It includes an outer ring 24, press-formed of steel sheet, press-fit into an inner circumference 4a of the intermediate gear 4. A plurality of needle rollers 26 is contained in the outer ring 24, via a cage 25. This needle bearing is readily available and thus reduces the manufacturing cost.

Ring shaped washers 28, 28 are installed on both sides of the intermediate gear 4. This prevents direct contact of the intermediate gear 4 against the first and second housings 2a, 2b. In this case, a face width of the teeth 4b of the intermediate gear 4 is formed smaller than an axial width of gear. This reduces the contact area between the intermediate gear 4 and the washers 28 and their frictional resistance to obtain smooth rotational performance. The washers 28 are flat washers press-formed of austenitic stainless steel sheet or preservative cold rolled steel sheet. The washer 28 has high strength and frictional resistance. Alternatively, the washers 28 may be formed of brass, sintered metal or thermoplastic synthetic resin such as PA (polyamide) 66 etc., with a predetermined amount of fiber reinforcing material such as GF (glass fiber) etc.

In addition, the width of the rolling bearing 23 is set smaller than the width of the intermediate gear 4. This prevents wear or deformation of sides of the bearing. Thus, the bearing obtains smooth rotation.

FIG. 4 shows a modification of the structure of FIG. 3. The intermediate gear 29 is rotationally supported on the gear shaft 22 mounted on the first and second housings 2a, 2b, via a sliding bearing 30. In this embodiment, the face width of the teeth 29b is formed the same as the axial width of gear 29. The sliding bearing 30 is structured as an oil impregnated bearing (such as “BEARFIGHT” (registered trade mark of NTN corporation). It has a porous metal including graphite micro-powder with a larger width than that of the intermediate gear 29. The sliding bearing is press-fit into the inner circumference 29a of the intermediate gear 29. This prevents the intermediate gear 29 contacting and wearing against the first and second housings 2a, 2b without mounting any washer. This provides smooth rotational performance while suppressing frictional resistance during rotation of the intermediate gear 29. This reduces the manufacturing cost while suppressing an increase in the number of components. The sliding bearing 30 may be formed by injection molding of thermoplastic polyimide resin.

As shown in FIG. 5, the sleeve 17 axially movably supporting the screw shaft 10 is fit in the blind bore 12 of the second housing 2b. The sleeve 17 is formed of medium carbon steel such as S 55C or case hardened steel such as SCM 415 or SCM 420 by a cold rolling method. Its surface is hardened to HRC 55 to 62 by induction hardening or carburizing hardening. This improves mass-production and reduces manufacturing cost. As shown in FIGS. 6(a) and 6(b), the sleeve 17 has a large diameter portion 31 on its one end. A cylindrical portion 32 axially extends from the large diameter portion 31. The large diameter portion 31 is formed with diametrically opposed flat portions 31a. An axially extending small protruding ridge 33 is formed at substantially the center of each flat portion 31a.

The blind bore 12 of the second housing 2b, where the sleeve 17 is fit, is formed with flat surfaces 34, 34 corresponding to the flat portions 31a of the sleeve 17. The blind bore and flat surfaces 34, 34 are formed by an aluminum die casting method that contributes to improving mass-production and the reduction of manufacturing cost. The flat portions 31a of the sleeve 17 are press-fit into the flat surfaces 34. A small pressure prevents rotation of the sleeve 17 relative to the housing 2b without any play between them (see FIG. 5). While oppositely arranged paired flat portions 31a and paired flat surfaces 34 of the second housing 2b are illustrated, it is possible to prevent the rotation of the sleeve 17 relative to the housing 2b by using a single flat portion and single flat surface.

As shown in FIG. 6(a), the recessed grooves 17a and the flat portions 31a of the sleeve 17 are arranged at positions circumferentially 90° apart from each other. This assures the strength and rigidity of the sleeve 17. In addition, the number of protruded ridge 33 may be increased to 2 or 3 to optimize the press-fitting ability and enable the amount of play at the press-fit portion due to wear with time.

A modified sleeve 35 of the sleeve 17 is shown in FIG. 6(c). The sleeve 35 is formed of medium carbon steel such as S 55C or case hardened steel such as SCM 415 or SCM 420 by a cold rolling method. The sleeve 35 includes a large diameter portion 36 on its one end. A cylindrical portion 37 axially extends from the large diameter portion 36. The inner circumference of the sleeve 35 is formed with axially extending recessed grooves 17a, 17a at diametrically opposite positions. The outer circumference of the sleeve 35 is formed with projecting portions 38, 38. Each projecting portion has a semicircular cross-section and semispherical end at positions where the recessed grooves 17a, 17a are formed.

As shown in FIGS. 7 and 8, a blind bore 39 of the housing 2b′, where the sleeve 35 is fit, includes recessed grooves 40, 40. Each recessed groove has a circular-arc cross-section that engages with the projecting portions 38, 38. The radius of curvature of each recessed groove 40 of the blind bore 39 of the housing 2b′ is smaller than each projecting portion 38 of the sleeve 35. This prevents rotation of the sleeve 35 relative to the housing 2b′ without any play.

Further according to the present embodiment, the blind bore 39 in the second housing 2b′ is formed with a guiding portion 41, shown by hatchings in FIG. 8. The guiding portion 41 has a cone configuration concentrated toward the recessed portion 40. This makes it possible to smoothly and precisely press-fit the sleeve 35 into the blind bore 39 of the housing 2b′. Thus, this improves the assembly operation without preparing special assembling devices such as positioning jigs.

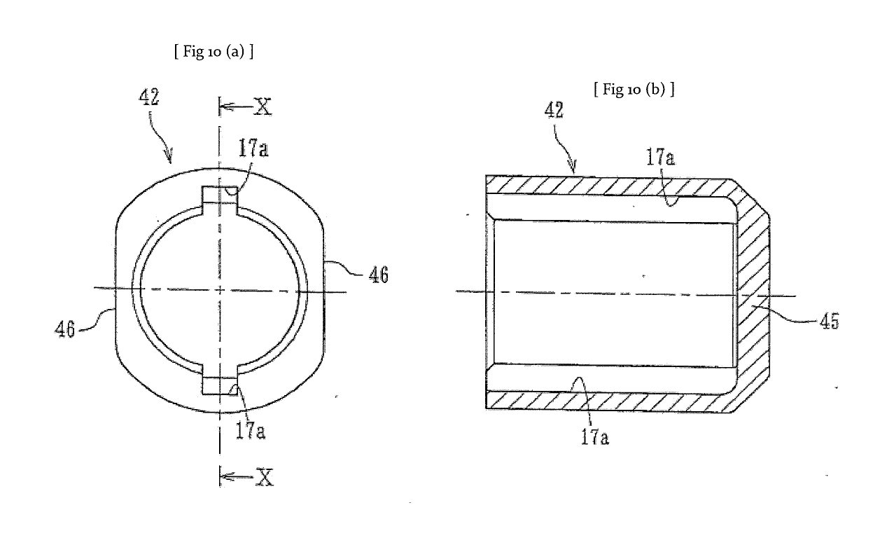

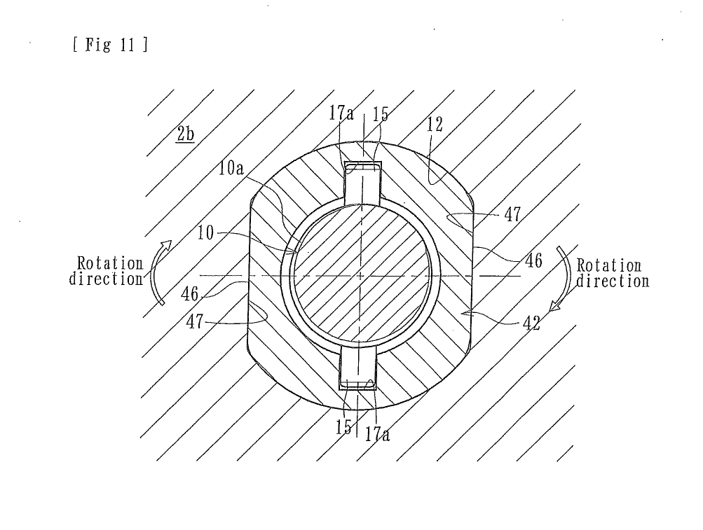

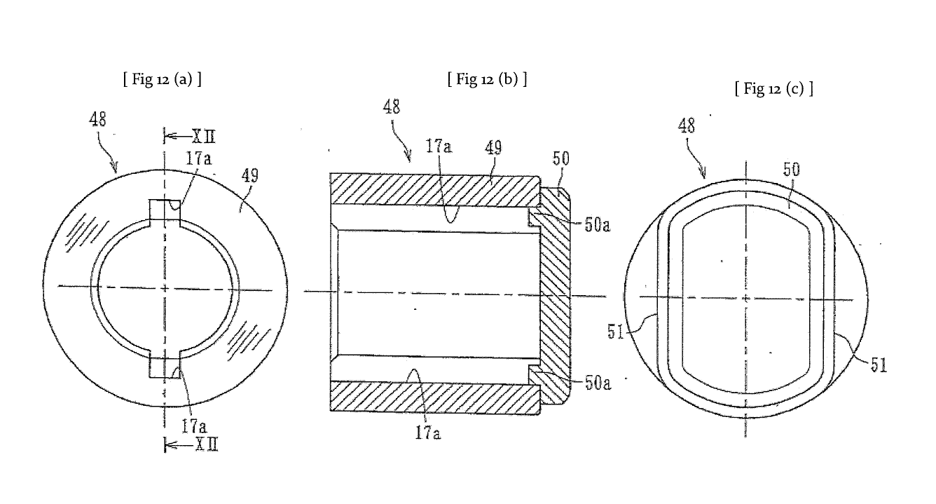

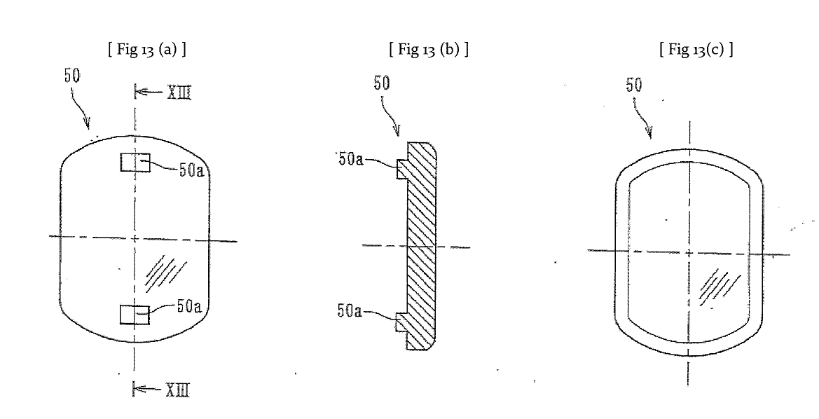

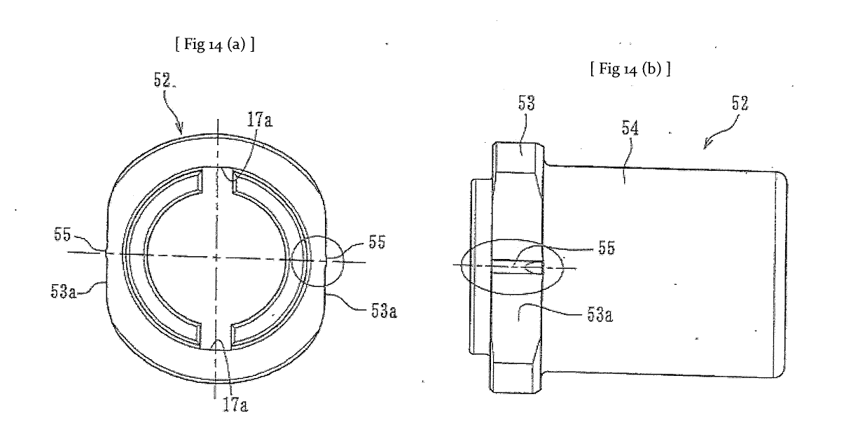

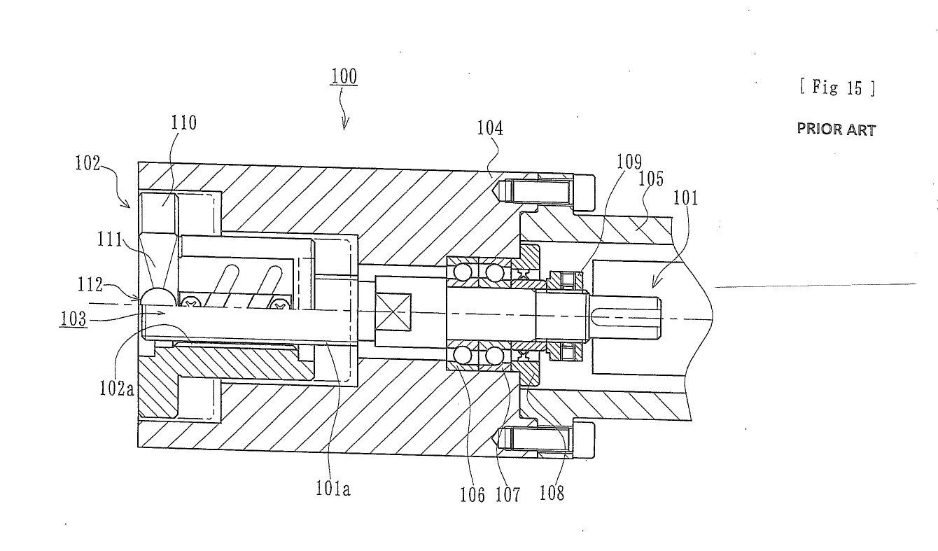

FIG. 9 is a longitudinal section view of a second embodiment of an electric linear actuator. FIG. 10(a) is a front elevation view of a sleeve of FIG. 9. FIG. 10(b) is a longitudinal section view taken along a line X-X of FIG. 10(a). FIG. 11 is a cross-section view taken along a line XI-XI of FIG. 9. FIG. 12(a) is a front elevation view of a modification of the sleeve of FIG. 10. FIG. 12(b) is a cross-section view taken along a line XII-XII of FIG. 12(a). FIG. 12(c) is a rear elevation view of the sleeve of FIG. 12(a). FIG. 13(a) is a front elevation view of a bottom plate of the sleeve of FIG. 12. FIG. 13(b) is a cross-section view taken along a line XIII-XIII of FIG. 13(a). FIG. 13(c) is a rear elevation view of the bottom plate of the sleeve of FIG. 13(a). FIG. 14(a) is a front elevation view of another modification of the sleeve of FIG. 10. and FIG. 14(b) is a side elevation view of the sleeve of FIG. 14(a). The second embodiment is basically different from the first embodiment only in the structure of the sleeve. Therefore, the same structural elements as those of the first embodiment will be denoted with the same reference numerals as those used in the first embodiment and their detailed description will be omitted.

As shown in FIG. 9, the electric linear actuator of this embodiment has a cylindrical housing 2, an electric motor (not shown) mounted on the housing 2, an intermediate gear 4 mating with an input gear 3 mounted on the motor shaft 3a of the motor. A speed reduction mechanism 6, including an output gear 5, mates with the intermediate gear 4. A ball screw mechanism 8 converts rotational motion of the electric motor, transmitted via the speed reduction mechanism 6, to axial linear motion of a drive shaft 7. An actuator main body 9 includes the ball screw mechanism 8.

The drive shaft 7 is integrally formed with the screw shaft 10, forming a part of the ball screw mechanism 8. A guide pin 15 is mounted on one end of the drive shaft 7. In addition, a sleeve 42, described later in more detail, is fit in the blind bore 12 of the second housing 2b. The guide pins 15, 15 of the screw shaft 10 engage in axially extending recessed grooves 17a, 17a formed on the inner circumference of the sleeve 42. Thus, the screw shaft 10 can be axially moved but is not rotated relative to the sleeve 42.

In this embodiment, an annular groove 43 is formed on the opening of the blind bore 12 of the second housing 2b. Falling-out of the sleeve 42, from the blind bore 12, is prevented by a stopper ring 44 snap-fit in the annular groove 43. It is preferable to use a wave washer as the stopper ring 44. The wave washer is press-formed of cold rolled steel sheet. Thus, it urges the end face of the sleeve 42 to prevent the generation of axial play of the sleeve 42.

The sleeve 42 is formed of sintered alloy by an injection molding machine for molding plastically prepared metallic powder. In this injection molding, metallic powder and binder comprising plastics and wax are firstly mixed and kneaded by a mixing and kneading machine to form pellets from the mixed and kneaded material. The pellets are fed into a hopper of the injection molding machine and then pushed into dies under a heated and melted condition. This forms the sleeve by a so-called MIM (Metal Injection Molding) method. The MIM method can easily mold sintered alloy material to article having desirable accurate configurations and dimensions. These articles require high manufacturing technology and have configurations that are hard to form.

One example of the metallic powder is shown such as SCM 415. It can be carburization quenched later. It has a composition of C: 0.13% by weight, Ni: 0.21% by weight, Cr: 1.1% by weight, Cu: 0.04% by weight, Mn: 0.76% by weight, Mo: 0.19% by weight, Si: 0.20% by weight, and remainder: Fe. The sleeve 42 is formed by controlling temperature of carburization quenching and tempering. Other materials can be used for the sleeve 42 such as FEN 8 of Japanese Powder Metallurgy Industry Standard. It has excellent formability and rust resistance. It includes Ni: 3.0 to 10.0% by weight or precipitation hardening stainless steel SUS 630 including C: 0.07% by weight, Cr: 17% by weight, Ni: 4% by weight, Cu: 4% by weight, and remainder: Fe. The surface hardness of SUS 630 can be increased within a range of HRC 20 to 33 by solution treatment to obtain both high toughness and hardness.

As shown in FIG. 10, the sleeve 42 has a cup-shaped configuration and includes a bottom portion 45. The bottom portion 45 is fit into the blind bore 12 until it is in close contact with the bottom of the blind bore 12. Axially extending recessed grooves 17a, 17a engage with the guide pins. The recessed grooves 17a, 17a are formed by cutting on the inner circumference of the sleeve 42 at diametrically opposite positions. Flat surfaces 46, 46 are formed on the outer circumference of the sleeve 42. The flat surfaces 46, 46 are arranged at positions circumferentially 90° apart from the recessed grooves 17a, 17a. This assures the strength and rigidity of the sleeve 42.

As shown in FIG. 11, the blind bore 12 of the second housing 2b is formed with flat surfaces 47, 47 that correspond to the flat portions 46, 46 of the sleeve 42. Engagement of the flat surfaces 47, 47 and the flat portions 46, 46 prevents rotation of the sleeve 42 relative to the housing 2b. This simplifies the configuration of the sleeve 42, reduce weight, manufacturing steps and costs. This provides an electric linear actuator that can reduce damage and wear of the second housing 2b and has excellent durability, strength and reliability. While described as paired flat portions of the sleeve 42 and paired flat surfaces of the housing 2b, only one flat portion and flat surface may need be formed, respectively, on the sleeve 42 and housing 2b. Falling-out of the sleeve 42 from the blind bore 12 is prevented by the stopper ring 42 (see FIG. 9).

FIG. 12 shows a modified sleeve 48 of the previously described sleeve 42 (FIG. 10). The sleeve 48 includes a cup-shaped configuration. It has a cylindrical sleeve main body 49 and a bottom plate 50 fit into one end of the sleeve main body 49. The sleeve 48 is fit into the blind bore 12 of the second housing 2b until the bottom plate 50 is in close contact with a bottom of the blind bore 12 of the housing 2b. Flat portions 51, 51 are formed on the outer circumference of the sleeve main body 49 at diametrically opposed positions and at substantially orthogonal positions relative to the recessed grooves 17a, 17a. This eliminates thinned wall portion of the sleeve 48. Thus, this assures the strength of the sleeve 48. The two-piece structure of the sleeve 48 can simplify the structure of the sleeve 48 and improve mass-production. Similarly to the previously described sleeve 42, this sleeve 48 is prevented from axially falling out from the blind bore 12 by the stopper ring 44. Also, in this case, the contact surface between the sleeve 48 and the stopper ring 44 is circular. Thus, it is possible to maintain uniform urging force applied to the sleeve 48 by the stopper ring 44 and stably hold the sleeve 48 without any axial play.

As shown in FIG. 13, the bottom plate 50 of the sleeve 48 has an outline corresponding to the configuration of the sleeve main body 49. A pair of projections 50a, 50a is integrally formed on a side mounted to the end face of the sleeve main body 49. The bottom plate 50 can be mounted on the sleeve main body 49 by fitting the projections 50a, 50a in the recessed grooves 17a, 17a.

FIGS. 14(a) and 14(b) show another modified sleeve 52 of the previously described sleeve 42 (FIG. 10). The sleeve 52 has a large diameter portion 53. A cylindrical portion 54 axially extends from the large diameter portion 53. A pair of diametrically opposed flat portions 53a, 53a is formed on the larger diameter portion 53. Axially extending small protruding ridges 55 are also formed on the flat portions 53a, 53a substantially at their center. As clearly shown in FIG. 14(a), the recessed grooves 17a, 17a are arranged at positions 90° apart from the flat portions 53a, 53a to keep the strength and rigidity of the sleeve 52. In addition, the number of protruded ridge 55 may be increased to 2 or 3 to optimize the press-fitting ability and enable an amount of play at the press-fit portion due to wear with time.

The electric linear actuator of the present disclosure can be applied to electric linear actuators used in an electric motor for general industries and driving sections of an automobile etc. The actuators have ball screw mechanisms that convert the rotational input from an electric motor into the linear motion of a drive shaft.

The present disclosure has been described with reference to the preferred embodiments. Obviously, modifications and alternations will occur to those of ordinary skill in the art upon reading and understanding the preceding detailed description. It is intended that the present disclosure be construed to include all such alternations and modifications insofar as they come within the scope of the appended claims or their equivalents.

What is claimed is:

1. An electric linear actuator comprising:
a housing formed from aluminum alloy;
an electric motor mounted on the housing;
a speed reduction mechanism reducing rotational speed of the electric motor via a motor shaft;
a ball screw mechanism converting rotational motion of the electric motor, transmitted via the speed reduction mechanism, to axial linear motion of a drive shaft, the ball screw mechanism comprising a nut and a screw shaft, the nut includes a helical screw groove on its inner circumference, the nut is rotationally supported by bearings mounted on the housing but is axially immovable with respect to the housing, the screw shaft is coaxially integrated with the drive shaft, the screw shaft includes a helical screw groove on its outer circumference corresponding to the helical screw groove of the nut, the screw shaft inserts into the nut, via a large number of balls, and the screw shaft is axially movably supported on the housing but is not rotatable with respect to the housing;
an anti-rotation mechanism for the screw shaft relative to the housing, the anti-rotation mechanism including a sleeve and a guide pin, the sleeve fits into the blind bore of the housing, the guide pin mounts on the end of the screw shaft, via a through-aperture in the screw shaft, the guide pin engages linear recessed grooves of the sleeve; and
the sleeve is fit into a blind bore of the housing so that flat portions formed on an outer circumference of the sleeve engage flat surfaces formed on an inner circumference of the blind bore of the housing to prevent rotation of the sleeve relative to the housing.

2. The electric linear actuator of claim 1, wherein the recessed grooves and the flat portions of the sleeve are formed, respectively, as pairs at circumferentially opposite positions to each other and the paired recessed grooves and the flat portions of the sleeve are positioned at circumferentially different phase positions to each other.

3. The electric linear actuator of claim 1, wherein a small protruding ridge is formed on each flat portion of the sleeve, the ridge is press-fit onto the flat surfaces of the blind bore.

4. The electric linear actuator of claim 3, wherein a plurality of small protruding ridges are formed on the flat portions of the sleeve.

5. The electric linear actuator comprising:
a housing formed of aluminum alloy;
an electric motor mounted on the housing;
a speed reduction mechanism reducing rotational speed of the electric motor via a motor shaft;
a ball screw mechanism for converting rotational motion of the electric motor, transmitted via the speed reduction mechanism, to axial linear motion of a drive shaft, the ball screw mechanism comprising a nut and a screw shaft, the nut includes a helical screw groove on its inner circumference, the nut is rotationally supported by bearings mounted on the housing but is axially immovable with respect to the housing, the screw shaft is coaxially integrated with the drive shaft, the screw shaft including a helical screw groove on its outer circumference corresponding to the helical screw groove of the nut, the screw shaft inserts into the nut via a large number of balls, the screw shaft is axially movably supported on the housing but is not rotatable with respect to the housing;
an anti-rotation mechanism for preventing rotation of the screw shaft relative to the housing, the anti-rotation mechanism including a sleeve and a guide pin, the sleeve fit into the blind bore of the housing, the guide pin mounts on the end of the screw shaft via a through-aperture in the screw shaft, the guide pin engages linear recessed grooves of the sleeve; and
the sleeve is fit into a blind bore of the housing so that projecting portions, each having a semicircular cross-section, formed on an outer circumference of the sleeve engage recessed grooves, each having a circular-arc cross-section, on an inner circumference of the blind bore of the housing to prevent rotation of the sleeve relative to the housing.

6. The electric linear actuator of claim 5, wherein the radius of curvature of the recessed groove on the blind bore of the housing is smaller than that of the projecting portion of the sleeve.

7. The electric linear actuator of claim 5, wherein the blind bore of the housing includes a guiding portion with a cone configuration concentrated toward the recessed portion.

8. The electric linear actuator of claim 5, wherein the blind bore of the housing includes an annular groove, a stopper ring is snap-fit into the annular groove, and a peripheral edge of the stopper ring is tapered.

9. The electric linear actuator of claim 5, wherein the sleeve is formed by a cold rolling method and the blind bore is formed by an aluminum die casting method.
